(19) United States
(12) Patent Application Publication
(10) Pub. No.: US 2010/0100379 A1
(43) Pub. Date: Apr. 22, 2010

(54) VOICE RECOGNITION CORRELATION RULE LEARNING SYSTEM, VOICE RECOGNITION CORRELATION RULE LEARNING PROGRAM, AND VOICE RECOGNITION CORRELATION RULE LEARNING METHOD

(75) Inventor: Kenji Abe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/644,906

(22) Filed: Dec. 22, 2009

Related U.S. Application Data
(63) Continuation of application No. PCT/JP2007/064957, filed on Jul. 31, 2007.

(51) Int. Cl. G10L 15/26

(52) U.S. Cl. 704/235; 704/254; 704/252; 704/E15.043

(57) ABSTRACT

A speech recognition rule learning device is connected to a speech recognition device that uses conversion rules for conversion between a first-type character string expressing a sound and a second-type character string for forming a recognition result. The character string recording unit records a first-type character string and a corresponding second-type character string. The extraction unit extracts second-type learned character string candidates. The rule learning unit extracts, from the second-type learned character string candidates, a second-type learned character string that matches at least part of the second-type character string in the character string recording unit; extracts a first-type learned character string from the first-type character string in the character string recording unit; and adds the correspondence relationship between the first-type learned character string and the second-type learned character string to the conversion rules.

### CROSS-REFERENCE TO RELATED APPLICATION

This application is based upon and claims the benefit of priority of the prior International Patent Application No. PCT/JP2007/064957, filed on Jul. 31, 2007, the entire contents of which are incorporated herein by reference.

### FIELD

The present invention relates to a device that automatically learns conversion rules used in the correlation process of speech recognition when, for example, converting a symbol string that corresponds to sounds in voice input into a character string (hereinafter, called a recognized character string) that forms a recognized vocabulary word.

### BACKGROUND

The correlation process performed by a speech recognition device includes, for example, processing for extrapolating a recognized character string (e.g., a syllable string) from a symbol string (e.g., a phoneme string) that corresponds to sounds extracted based on acoustic features of voice input. Here, conversion rules (also called correlation rules or rules) that associate phoneme strings and syllable strings are necessary. Such conversion rules are recorded in the speech recognition device in advance.

Typically, when defining conversion rules for phoneme strings and symbol strings for example, it has been commonplace for the basic unit (conversion unit) of a conversion rule to be data that associates a plurality of phonemes with one syllable For example, in the case in which the two phonemes /k/ /a/ correspond to the one syllable “ka”, the conversion rule indicating this association is expressed as “ka→ka”.

However, when the speech recognition device performs correlation using a short unit of one syllable, there are cases in which there is an increase in the number of solution candidates when forming a recognized vocabulary word from a syllable string, and the correct solution candidate is missed due to erroneous detection or pruning. Also, there are cases in which a phoneme string that corresponds to one syllable changes depending on an adjacent syllable before or after that syllable, and conversion rules defined using one-syllable units cannot express such changes.

In view of this, it is possible to suppress cases in which the correct solution candidate is missed and express such changes by, for example, adding rules associating phoneme strings with syllable strings composed of a plurality of syllables to the conversion rules, thus lengthening the syllable string conversion unit. For example, in the case in which the three phonemes /k/ /a/ /i/ correspond to the two syllables “ka i”, the conversion rule that indicates this association is expressed as “ka i→kai”. Also, as another example of lengthening the conversion unit of the conversion rules, an example has also been disclosed in which an unfixed-length acoustic model is automatically created without limiting the model unit of HMM to only a phoneme (e.g., see Japanese Laid-open Patent Publication No. H08-123477A).

However, if the conversion unit is lengthened, the amount of conversion rules tends to become enormous. For example, in the case of adding conversion rules whose conversion unit is three syllables to the conversion rules for syllable strings and phoneme strings, there is an enormous number of three-syllable combinations, and if all of such combinations are to be covered, the number of conversion rules that are to be recorded becomes enormous. As a result, an enormous amount of memory is necessary to record the conversion rules, and an enormous amount of time is necessary to perform processing using the conversion rules.

### DISCLOSURE OF INVENTION

### SUMMARY

A speech recognition rule learning device according to the present invention is connected to a speech recognition device that generates a recognition result by executing correlation processing which matches input voice data with an acoustic model and a word dictionary by using conversion rules for conversion between a first-type character string expressing a sound and a second-type character string for forming a recognition result. The speech recognition rule learning device includes: a character string recording unit that records, in association with each other, a first-type character string generated in a process in which a recognition result is generated by the speech recognition device, and a second-type character string corresponding to the first-type character string; an extraction unit that extracts, from a second-type character string corresponding to a word recorded in the word dictionary, character strings each constituted by a series of second-type elements that are constituent units of the second-type character string, as second-type learned character string candidates; and a rule learning unit that (i) selects a second-type learned character string, from among the second-type learned character string candidates extracted by the extraction unit, that matches at least part of the second-type character string recorded in the character string recording unit, (ii) extracts, from the first-type character string recorded in the character string recording unit in association with the second-type character string, a portion that corresponds to the second-type learned character string, as a first-type learned character string, and (iii) includes, in the conversion rules used by the speech recognition device, data indicating a correspondence relationship between the first-type learned character string and the second-type learned character string.

The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a function block diagram depicting a configuration of a rule learning device and a speech recognition device.

FIG. 2 is a function block diagram depicting a configuration of a speech recognition engine of the speech recognition device.

FIG. 3 is a diagram depicting an example of the content of data stored in a recognized vocabulary recording unit.

FIG. 4 is a diagram depicting an example of the content of data recorded in a basic rule recording unit.

FIG. 5 is a diagram depicting an example of the content of data recorded in a learned rule recording unit.

FIG. 6 is a diagram depicting an example of the content of data recorded in a sequence A & sequence B recording unit.

FIG. 7 is a diagram depicting an example of the content of data recorded in a candidate recording unit.

FIG. 8 is a flowchart depicting processing in which data for initial learning is recorded in a sequence A & sequence B recording unit 3.

FIG. 9 is a flowchart depicting processing in which a rule learning unit performs initial learning with use of data recorded in the sequence A & sequence B recording unit.

FIG. 10 is a diagram conceptually depicting the correspondence relationship between sections of a syllable string Sx and a phoneme string Px.

FIG. 11 is a flowchart depicting re-learning processing performed by an extraction unit and the rule learning unit.

FIG. 12 is a diagram conceptually depicting the correspondence relationship between sections of a syllable string Si and a phoneme string Pi.

FIG. 13 is a flowchart depicting an example of unnecessary rule deletion processing performed by a reference character string creation unit and an unnecessary rule determination unit.

FIG. 14 is a diagram depicting an example of the data content of conversion rules recorded in the learned rule recording unit.

FIG. 15 is a diagram depicting an example of the content of data recorded in the sequence A & sequence B recording unit.

FIG. 16 is a diagram conceptually depicting the correspondence relationship between sections of a sequence Aphonetic symbol string and sections of a sequence B word string.

FIG. 17 is a diagram depicting an example of the content of data recorded in the learned rule recording unit.

FIG. 18 is a diagram depicting an example of the content of data stored in the recognized vocabulary recording unit.

FIG. 19 is a diagram depicting an example of a sequence B pattern extracted from words in the recognized vocabulary recording unit.

FIG. 20 is a diagram conceptually depicting the correspondence relationship between sections of a sequence Aphonetic symbol string and sections of a sequence B word string.

FIG. 21 is a diagram depicting an example of the content of data recorded in a basic rule recording unit 4.

### DESCRIPTION OF EMBODIMENTS

In the speech recognition rule learning device including the above configuration, the extraction unit extracts, as second-type learned character string candidates, second-type character strings composed of a plurality of second-type elements corresponding to words in the word dictionary. The rule learning unit extracts, from among the extracted second-type learned character string candidates, a character string that matches at least part of the second-type character string corresponding to the first-type character string acquired from the voice detection device, as a second-type learned character string. Then, the rule learning unit sets a portion of the first-type character string that corresponds to the second-type learned character string as a first-type learned character string, and includes, in the conversion rules, data indicating the correspondence relationship between the first-type learned character string and the second-type learned character string. Accordingly, a second-type learned character string composed of a plurality of successive second-type elements is extracted from a word in the word dictionary that can be a recognition target of the speech recognition device, and a conversion rule indicating the correspondence relationship between such second-type learned character string and the first-type learned character string is added. As a result, a conversion rule that includes conversion unit as a plurality of successive second-type elements and that furthermore has a high possibility of being used by the speech recognition device is learned. For this reason, it is possible to automatically learn a new conversion rule whose conversion unit is a plurality of second-type elements without increasing the number of unnecessary conversion rules (or unnecessary rules). As a result, it is possible to improve the recognition accuracy of a speech recognition device that performs processing for conversion between first-type character strings and second-type character strings with use of conversion rules.

The speech recognition rule learning device may further include: a basic rule recording unit that has recorded in advance basic rules that are data indicating ideal first-type character strings that respectively correspond to the second-type elements that are constituent units of the second-type character string; and an unnecessary rule determination unit that generates, as a first-type reference character string, a first-type character string corresponding to the second-type learned character string with use of the basic rules, calculates a value indicating a degree of similarity between the first-type reference character string and the first-type learned character string, and determines that, if the value is in a given allowable range, the first-type learned character string is to be included in the conversion rules.

The basic rules are data that stipulates an ideal first-type character string corresponding to each second-type element which is the constituent unit of the second-type character string. With use of these basic rules, the unnecessary rule determination unit can generate a first-type reference character string by replacing each of the second-type elements constituting the second-type learned character string with a corresponding first-type character string. For this reason, when compared with the first-type learned character string, the first-type reference character string tends to have a lower possibility of being an erroneous conversion. If a value indicating a degree of similarity between such a first-type reference character string and a first-type learned character string is in a given allowable range, the unnecessary rule determination unit determines that data indicating the correspondence relationship between the first-type learned character string and the second-type learned character string is to be included in the conversion rules. For this reason, the unnecessary rule determination unit can make determinations so that data that has a high possibility of causing an erroneous conversion is not to be included in the conversion rules. As a result, it is possible to suppress an increase in the number of unnecessary conversion rules and the occurrence of erroneous conversion.

In the speech recognition rule learning device the unnecessary rule determination unit may calculate the value indicating the degree of similarity based on at least one of a difference between character string lengths of the first-type reference character string and the first-type learned character string, and a percentage of identical characters in the first-type reference character string and the first-type learned character string.

Accordingly, whether the conversion rule for a first-type learned character string is necessary is determined based on the difference between the character string lengths of the first-type reference character string and a first-type learned character string or the percentage of identical characters therein. For this reason, for example, in the case in which there are very few identical characters in the first-type reference character string and the first-type learned character string, there is a big difference between the character string lengths, or the like, the unnecessary rule determination unit determines that the conversion rule regarding such first-type learned character string is unnecessary.

The speech recognition rule learning device may further include: an unnecessary rule determination unit that, if a frequency of appearance in the speech recognition device of at least one of the first-type learned character string extracted by the rule learning unit or the second-type learned character string is in the given allowable range, determines that the data indicating the correspondence relationship between the first-type learned character string and the second-type learned character string is to be included in the conversion rules.

Accordingly, this suppresses the case in which data indicating the correspondence relationship between a first-type learned character string that has a low frequency of appearance in the speech recognition device and a second-type learned character string is included in the conversion rules, thus suppressing an increase in the number of unnecessary conversion rules. Note that the frequency of appearance may be obtained by recording an appearance each time an appearance is detected by the speech recognition device. Such frequency of appearance may be recorded by the speech recognition device, or may be recorded by the speech recognition rule learning device.

The speech recognition rule learning device may further include: a threshold value recording unit that records allowable range data indicating the given allowable range; and a setting unit that receives an input of data indicating an allowable range from a user, and updates the allowable range data recorded in the threshold value recording unit based on the input.

Accordingly, the user can adjust the allowable range of degrees of similarity between the first-type learned character string and the first-type reference character string, which is the reference used in unnecessary rule determination.

A speech recognition device according to the present embodiment includes: a speech recognition unit that generates a recognition result by executing correlation processing which matches input voice data with an acoustic model and a word dictionary; a rule recording unit that records conversion rules that are used by the speech recognition unit in the correlation processing and that are for conversion between a first-type character string expressing a sound and a second-type character string for forming a recognition result; a character string recording unit that records, in association with each other, a first-type character string generated in a process in which a recognition result is generated by the speech recognition unit, and a second-type character string corresponding to the first-type character string; an extraction unit that extracts, from a second-type character string corresponding to a word recorded in the word dictionary, character strings each constituted by a series of second-type elements that are constituent units of the second-type character string, as second-type learned character string candidates; and a rule learning unit that (i) selects a second-type learned character string, from among the second-type learned character string candidates extracted by the extraction unit, that matches at least part of the second-type character string recorded in the character string recording unit, (ii) extracts, from the first-type character string recorded in the character string recording unit in association with the second-type character string, a portion that corresponds to the second-type learned character string, as a first-type learned character string, and (iii) includes, in the conversion rules used by the speech recognition unit, data indicating a correspondence relationship between the first-type learned character string and the second-type learned character string.

A speech recognition rule learning method according to the present embodiment causes a speech recognition device that generates a recognition result by executing correlation processing which matches input voice data with an acoustic model and a word dictionary, to learn conversion rules that are used in the correlation processing and that are for conversion between a first-type character string expressing a sound and a second-type character string for forming a recognition result. The speech recognition rule learning method includes steps that are executed by a computer including a character string recording unit that records, in association with each other, a first-type character string generated in a process in which a recognition result is generated by the speech recognition device, and a second-type character string corresponding to the first-type character string, the steps being: a step in which an extraction unit included in the computer extracts, from a second-type character string corresponding to a word recorded in the word dictionary, character strings each constituted by a series of second-type elements that are constituent units of the second-type character string, as second-type learned character string candidates; and a step in which a rule learning unit included in the computer (i) selects a second-type learned character string, from among the second-type learned character string candidates extracted by the extraction unit, that matches at least part of the second-type character string recorded in the character string recording unit, (ii) extracts, from the first-type character string recorded in the character string recording unit in association with the second-type character string, a portion that corresponds to the second-type learned character string, as a first-type learned character string, and (iii) includes, in the conversion rules used by the speech recognition device, data indicating a correspondence relationship between the first-type learned character string and the second-type learned character string.

A speech recognition rule learning program according to the present embodiment causes a computer to perform processing, the computer being connected to or included in a speech recognition device that that generates a recognition result by executing correlation processing which matches input voice data with an acoustic model and a word dictionary by using conversion rules for conversion between a first-type character string expressing a sound and a second-type character string for forming a recognition result. The speech recognition rule learning program causes the computer to execute: a process of accessing a character string recording unit that records, in association with each other, a first-type character string generated in a process in which a recognition result is generated by the speech recognition device, and a second-type character string corresponding to the first-type character string; an extraction process of extracting, from a second-type character string corresponding to a word recorded in the word dictionary, character strings each constituted by a series of second-type elements that are constituent units of the second-type character string, as second-type learned character string candidates; and a rule learning process of (i) selecting a second-type learned character string, from among the second-type learned character string candidates extracted in the extraction process, that matches at least part of the second-type character string recorded in the character string recording unit, (ii) extracting, from the first-type character string recorded in the character string recording unit in association with the second-type character string, a portion that corresponds to the second-type learned character string, as a first-type learned character string, and (iii) including, in the conversion rules used by the speech recognition device, data indicating a correspondence relationship between the first-type learned character string and the second-type learned character string.

According to the present embodiment, it is possible to improve the recognition accuracy of speech recognition by automatically adding, as conversion rules used in speech recognition, new conversion rules having changed conversion units to a speech recognition device without increasing the number of unnecessary conversion rules.

Overview of Configuration of Speech Recognition Device and Rule Learning Device

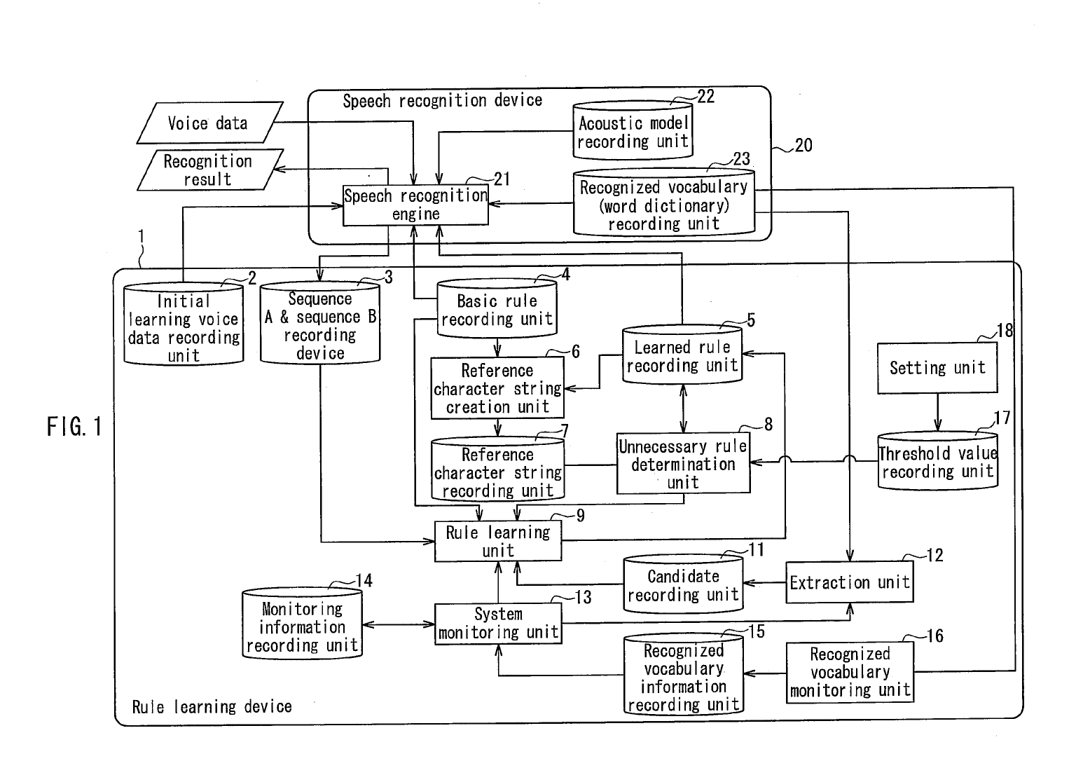

FIG. 1 is a function block diagram depicting one configuration of a rule learning device according to the present embodiment and a speech recognition device connected thereto. A speech recognition device 20 depicted in FIG. 1 is a device that receives an input of voice data, performs speech recognition, and outputs a recognition result. The speech recognition device 20 therefore includes a speech recognition engine 21, an acoustic model recording unit 22, and a recognized vocabulary (word dictionary) recording unit 23.

In speech recognition processing, the speech recognition engine 21 references the acoustic model recording unit 22 and the recognized vocabulary (word dictionary) recording unit 23, as well as a basic rule recording unit 4 and a learned rule recording unit 5 in the rule learning device 1. The basic rule recording unit 4 and the learned rule recording unit 5 record data indicating conversion rules that, in the process of the speech recognition processing, are used in conversion between a first-type character string (hereinafter, called a sequence A) that expresses sounds generated based on the acoustic features of voice data, and a second-type character string (hereinafter, called a sequence B) for obtaining a recognition result.

With use of such conversion rules, the speech recognition engine 21 performs conversion between sequences A generated in speech recognition processing and sequences B. The present embodiment describes the case in which each sequence A is a symbol string expressing sounds extracted based on the acoustic features of voice data, and each sequence B is a recognized character string that forms a recognized vocabulary word. Specifically, each sequence A is a phoneme string, and each sequence B is a syllable string. Note that as described later, the form of the sequences A and the sequences B is not limited to this.

The rule learning device 1 is a device for automatically learning conversion rules for such sequences A and sequences B, which are used in the speech recognition device 20. Basically, the rule learning device 1 generates a new conversion rule by receiving information regarding a sequence A and a sequence B from the speech recognition engine 21, and furthermore referencing data in the recognized vocabulary recording unit 23, and records the new conversion rule in the learned rule recording unit 5.

The rule learning device 1 includes a reference character string creation unit 6, a rule learning unit 9, an extraction unit 12, a system monitoring unit 13, a recognized vocabulary monitoring unit 16, a setting unit 18, an initial learning voice data recording unit 2, a sequence A & sequence B recording unit 3, the basic rule recording unit 4, the learned rule recoding unit 5, a reference character string recording unit 7, a candidate recording unit 11, a monitoring information recording unit 14, a recognized vocabulary information recording unit 15, and a threshold value recording unit 17.

Note that the configurations of the speech recognition device 20 and the rule learning device 1 are not limited to the configurations depicted in FIG. 1. For example, a configuration is possible in which the basic rule recording unit 4 and the learned rule recording unit 5 that record data indicating conversion rules are provided in the speech recognition device 20 instead of in the rule learning device 1.

Also, the speech recognition device 20 and the rule learning device 1 are configured by, for example, a general-purpose computer such as a personal computer or server machine. The functions of both the speech recognition device 20 and the rule learning device 1 can be realized with one general-purpose computer. A configuration is also possible in which the function units of the speech recognition device 20 and the rule learning device 1 are provided dispersed among a plurality of general-purpose computers connected via a network. Furthermore, the speech recognition device 20 and the rule learning device 1 may be configured by, for example, a computer incorporated in an electronic device such as an in-vehicle information terminal, a mobile phone, a game console, a PDA, or a home appliance.

The reference character string creation unit 6, rule learning unit 9, extraction unit 12, system monitoring unit 13, recognized vocabulary monitoring unit 16, and setting unit 18 function units of the rule learning device 1 are embodied by the operation of the CPU of a computer in accordance with a program for realizing the functions of such units. Accordingly, the program for realizing the functions of such function units and a recording medium having the program recorded thereon are also embodiments of the present invention. Also, the initial learning voice data recording unit 2, the sequence A & sequence B recording unit 3, the basic rule recording unit 4, the learned rule recording unit 5, the reference character string recording unit 7, the candidate recording unit 11, the monitoring information recording unit 14, the recognized vocabulary information recording unit 15, and the threshold value recording unit 17 are embodied by an internal recording device in a computer or a recording device that can be accessed from the computer.

Configuration of Speech Recognition Device 20

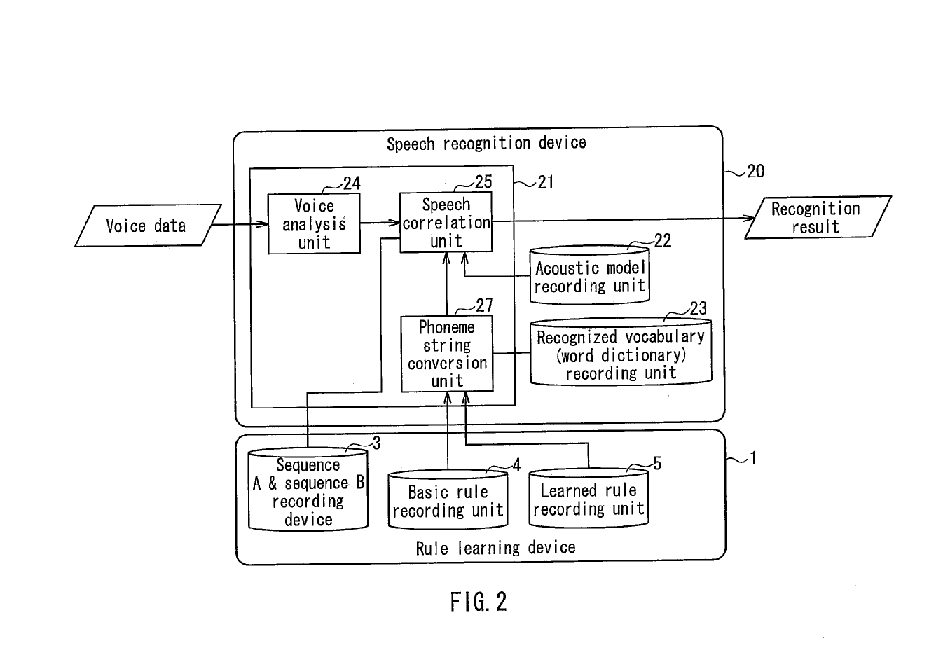

FIG. 2 is a function block diagram for describing the detailed configuration of the speech recognition engine 21 of the speech recognition device 20. Function blocks in FIG. 2 that are the same as function blocks in FIG. 1 have been given the same numbers. Also, the depiction of some function blocks has been omitted from the rule learning device 1 depicted in FIG. 2. The speech recognition engine 21 includes a voice analysis unit 24, a voice correlation unit 25, and a phoneme string conversion unit 27.

First is a description of the recognized vocabulary recording unit 23, the acoustic model recording unit 22, the basic rule recording unit 4, and the learned rule recording unit 5 that record data used by the speech recognition engine 21.

The acoustic model recording unit 22 records an acoustic model that models what phonemes readily have what sort of feature quantities. The recorded acoustic model is, for example, a phoneme HMM (Hidden Markov Model) that is currently the mainstream.

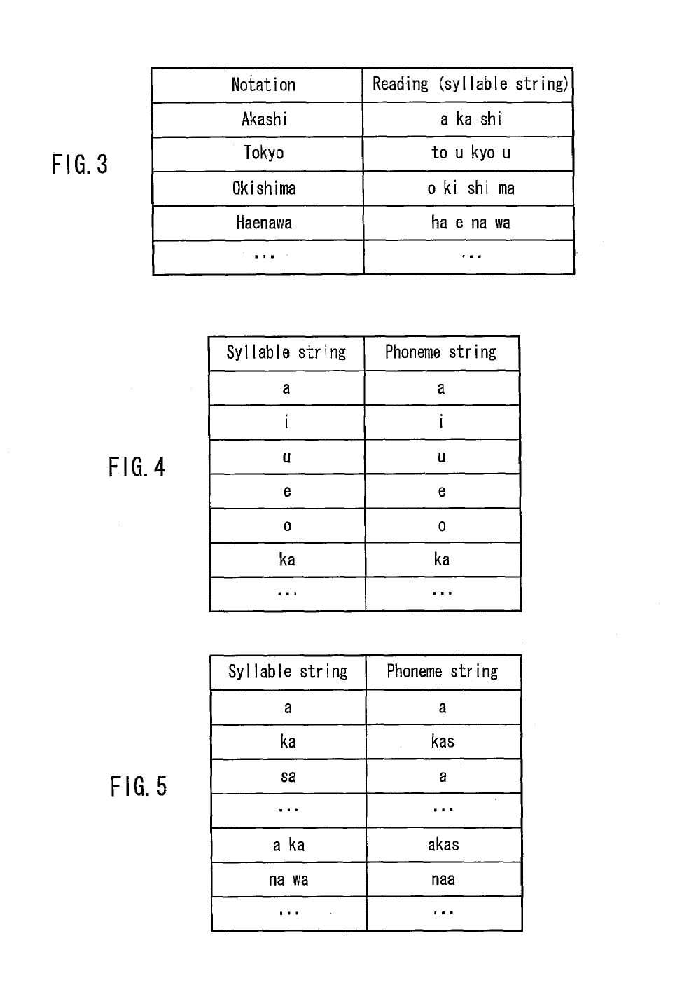

The recognized vocabulary recording unit 23 stores the readings of a plurality of recognized vocabulary words. FIG. 3 is a diagram depicting an example of the content of data stored in the recognized vocabulary recording unit 23. In the example depicted in FIG. 3, the recognized vocabulary recording unit 23 stores a notation and a reading for each recognized vocabulary word. As one example here, the readings are expressed as syllable strings.

For example, the notations and readings of recognized vocabulary words are stored in the recognized vocabulary recording unit 23 as a result of a user of the speech recognition device 20 causing the speech recognition device 20 to read a recording medium on which the notations and readings of the recognized vocabulary are recorded. Also, through a similar operation, the user can store the notations and readings of new recognized vocabulary in the recognized vocabulary recording unit 23, and can update the notations and readings of recognized vocabulary.

The basic rule recording unit 4 and the learned rule recording unit 5 record data indicating conversion rules for phoneme strings that are an example of the sequences A and syllable strings that are an example of the sequences B. The conversion rules are recorded as data indicating, for example, the correspondence relationship between phoneme strings and syllable strings.

The basic rule recording unit 4 records ideal conversion rules that have been created by someone in advance. The conversion rules in the basic rule recording unit 4 are, for example, conversion rules based on the premise of ideal voice data that does not take vocalization wavering or diversity into account. In contrast, the learned rule recording unit 5 records conversion rules that have been automatically learned by the rule learning device 1 as described later. Such conversion rules take vocalization wavering and diversity into account.

FIG. 4 is a diagram depicting an example of the content of data recorded in the basic rule recording unit 4. In the example depicted in FIG. 4, each syllable (the element that is the constituent unit of each sequence B), which is the constituent unit of a syllable string, is recorded along with a corresponding ideal phoneme string. Note that the content of the data recorded in the basic rule recording unit 4 is not limited to the data depicted in FIG. 4. For example, data that defines ideal conversion rules in units of two syllables or more may also be included.

FIG. 5 is a diagram depicting an example of the content of data recorded in the learned rule recording unit 5. In the example depicted in FIG. 5, one syllable or two syllables are each recorded along with a corresponding phoneme string obtained by learning. The learned rule recording unit 5 can record phoneme strings for syllable strings including two syllable or more, instead of being limited to one syllable or two syllables. The learning of conversion rules is described later.

The recognized vocabulary recording unit 23 may furthermore record, for example, grammar data such a CFG (Context Free Grammar) or FSG (Finite State Grammar), or a word concatenation probability model (N-gram).

Next is a description of the voice analysis unit 24, the voice correlation unit 25, and the phoneme string conversion unit 27. The voice analysis unit 24 converts input voice data into feature quantities for each frame. MFCCs (Mel Frequency Cepstral Coefficients), LPC (Linear Predictive Coding) cepstrums and powers, one-dimensional and two-dimensional regression coefficients thereof, as well as multi-dimensional vectors such as dimensional compressions of such values obtained by principal component analysis or discriminant analysis are often used as the feature quantities, but there is no particular limitation here on the feature quantities that are used. The converted feature quantities are recorded in an internal memory along with information specific to each frame (frame-specific information). Note that the frame-specific information is, for example, data expressing frame numbers indicating how many places from the beginning each frame is, and the start point, end point, and power of each frame.

The phoneme string conversion unit 27 converts the readings of recognized vocabulary stored in the recognized vocabulary recording unit 23 into phoneme strings in accordance with the conversion rules stored in the basic rule recording unit 4 and the learned rule recording unit 5. In the present embodiment, the phoneme string conversion unit 27 converts, for example, the readings of all the recognized vocabulary stored in the recognized vocabulary recording unit 23 into phoneme strings in accordance with the conversion rules. Note that the phoneme string conversion unit 27 may convert a recognized vocabulary word into a plurality of different phoneme strings.

For example, in the case of conversion with use of both the conversion rules in the basic rule recording unit 4 depicted in FIG. 4 and the conversion rules in the learned rule recording unit 5 depicted in FIG. 5, there are two conversion rules for the syllable “ka”, namely “ka→ka” and “ka→kas”, and therefore the phoneme string conversion unit 27 can convert a recognized vocabulary word including “ka” into two different phoneme strings.

The voice correlation unit 25 calculates a phoneme score for each frame included in a voice section by correlating the acoustic model in the acoustic model recording unit 22 and the feature quantities converted by the voice analysis unit 24. Furthermore, by correlating the phoneme score of each frame and the phoneme strings of each recognized vocabulary word converted by the phoneme string conversion unit 27, the voice correlation unit 25 calculates a score for each recognized vocabulary word. Based on the scores of the recognized vocabulary words, the voice correlation unit 25 determines a recognized vocabulary word to be output as the recognition result that is to be the recognition result.

For example, in the case in which grammar data is recorded in the recognized vocabulary recording unit 23, the voice correlation unit 25 can output, as the recognition result, a recognized vocabulary string (recognized sentence) with use of the grammar data.

The voice correlation unit 25 outputs the determined recognized vocabulary word as the recognition result, and records the reading (syllable string) of the recognized vocabulary word included in the recognition result and the corresponding phoneme string in the sequence A & sequence B recording unit 3. The data recorded in the sequence A & sequence B recording unit 3 is described later.

Note that the speech recognition device that is applicable in the present embodiment is not limited to the above configuration. The conversion is not limited to being between a phoneme string and a syllable string, but instead any speech recognition device that has a function of performing conversion between a sequence A expressing a sound and a sequence B for forming a recognition result is applicable in the present embodiment.

Configuration of Rule Learning Device 1

Next is a description of the configuration of the rule learning device 1 with reference to FIG. 1. The system monitoring unit 13 monitors the operating condition of the speech recognition device 20 and the rule learning device 1, and controls the operation of the rule learning device 1. For example, based on the data recorded in the monitoring information recording unit 14 and the recognized vocabulary information recording unit 15, the system monitoring unit 13 determines processing that is to be executed by the rule learning device 1, and instructs the function units to execute the determined processing.

The monitoring information recording unit 14 records monitoring data indicating the operating condition of the speech recognition device 20 and the rule learning device 1. Table 1 below is a table depicting an example of the content of the monitoring data.

TABLE 1

| Monitoring item | Value |
|---|---|
| Initial learning complete flag | 0 |
| Voice input standby flag | 0 |
| Conversion rule increase amount | 121 |
| Last re-learning date and time | 2007/1/1 19:08:07 |
| . . . | . . . |

In Table 1, “initial learning complete flag” is data indicating whether initial learning processing has been completed. For example, the initial learning complete flag is “0” as the initial setting of the rule learning device 1, and is updated to “1” by the system monitoring unit 13 when initial learning processing has been completed. Also, “voice input standby flag' is set to “1” if the speech recognition device 20 is waiting for voice input, and is set to “0” if otherwise. For example, the system monitoring unit 13 receives a signal indicating a condition from the speech recognition device 20, and the voice input standby flag can be set based on such signal. Also, “conversion rule increase amount” is the total number of conversion rules that have been added to the learned rule recording unit 5. Also, “last re-learning date and time” is the last date and time that the system monitoring unit 13 output an instruction to perform re-learning processing. Note that the monitoring data is not limited to the content depicted in Table 1.

The recognized vocabulary information recording unit 15 records data indicating the update condition of the recognized vocabulary recorded in the recognized vocabulary recording unit 23 of the speech recognition device 20. For example, update mode information indicating whether the recognized vocabulary has been updated (“ON' or “OFF') is recorded in the recognized vocabulary information recording unit 15. The recognized vocabulary monitoring unit 16 monitors the update condition of the recognized vocabulary in the recognized vocabulary recording unit 23, and sets the update mode information to “ON' if the recognized vocabulary has changed or recognized vocabulary has been newly registered.

For example, immediately after the program for causing a computer to function as the speech recognition device and the rule learning device has been installed in the computer, the “initial learning complete flag” in Table 1 is “0”. If “initial learning complete flag”=“0”, and furthermore “voice input standby flag”=“1”, the system monitoring unit 13 may determine that initial learning is necessary, and instruct the rule learning unit 9 to perform initial learning of conversion rules. As described later, at the time of initial learning, there is a need to input initial learning voice data to the speech recognition device 20, and therefore there is a need for the speech recognition device 20 to be waiting for input.

Also, for example, if the update mode information of the recognized vocabulary information recording unit 15 is “ON”, and furthermore a given time period has elapsed since “last re-learning date” in Table 1, the system monitoring unit 13 may determine that re-learning of conversion rules is necessary, and instruct the rule learning unit 9 and the extraction unit 12 to performing re-learning of conversion rules.

Also, for example, if “conversion rule increase amount” in Table 1 is a given value or higher, the system monitoring unit 13 may instruct the unnecessary rule determination unit 8 and the reference character string creation unit 6 to perform unnecessary rule determination. In this case, for example, by the system monitoring unit 13 resetting “conversion rule increase amount” whenever causing unnecessary rule determination to be executed, unnecessary rule determination can be executed whenever the conversion rules have increased by a given amount.

In this way, based on the monitoring data, the system monitoring unit 13 can determine whether the execution of initial learning of conversion rules is necessary whether unnecessary rule deletion determination is necessary, and the like. Also, based on the monitoring data and the update mode information, the system monitoring unit 13 can determine whether re-learning of conversion rules is necessary and the like. Note that the monitoring data recorded in the monitoring information recording unit 14 is not limited to the example in Table 1.

The initial learning voice data recording unit 2 records, as training data, voice data for which the recognition result is known in advance in association with recognition result character strings (as one example here, syllable strings). Such training data is obtained by, for example, recording the voice of the user of the speech recognition device 20 when the user reads aloud given character strings, and recording the recorded audio in association with the given character strings. The initial learning voice data recording unit 2 records, as training data, combinations of various character strings and speech data of a voice reading them aloud.

In the case of determining that initial learning of conversion rules is necessary, the system monitoring unit 13 first inputs voice data X from among the training data in the initial learning voice data recording unit 2 to the speech recognition device 20, and receives, from the speech recognition device 20, a phoneme string that has been calculated by the speech recognition device 20 and corresponds to the voice data X. The phoneme string corresponding to the voice data X is recorded in the sequence A & sequence B recording unit 3. Also, the system monitoring unit 13 retrieves a character string (syllable string) corresponding to the audio data X from the initial learning voice data recording unit 2, and records the retrieved character string in association with the recorded phoneme string in the sequence A & sequence B recording unit 3. Accordingly, the combination of the phoneme string and the syllable string that correspond to the initial learning voice data X is recorded in the sequence A & sequence B recording unit 3.

Thereafter, the system monitoring unit 13 outputs an instruction to perform initial learning to the rule learning unit 9. In the case of performing initial learning, the rule learning unit 9 performs initial learning of conversion rules with use of the combination of the phoneme string and the syllable string recorded in the sequence A & sequence B recording unit 3 and the conversion rules recorded in the basic rule recording unit 4, and records the learned conversion rules in the learned rule recording unit 5. In initial learning, for example, phoneme strings that respectively correspond to one syllable are learned, and each syllable and the corresponding phoneme strings are recorded in association with each other. Details of initial learning performed by the rule learning unit 9 are described later.

Note that the sequence A & sequence B recording unit 3 may record phoneme strings generated by the speech recognition device 20 based on arbitrary input voice data instead of initial learning voice data, and the syllable strings corresponding thereto. In other words, the rule learning device 1 may receive, from the speech recognition device 20, combinations of syllable strings and phoneme strings that have been generated by the speech recognition device 20 in the process of performing speech recognition on input voice data, and record the received combinations in the sequence A & sequence B recording unit 3.

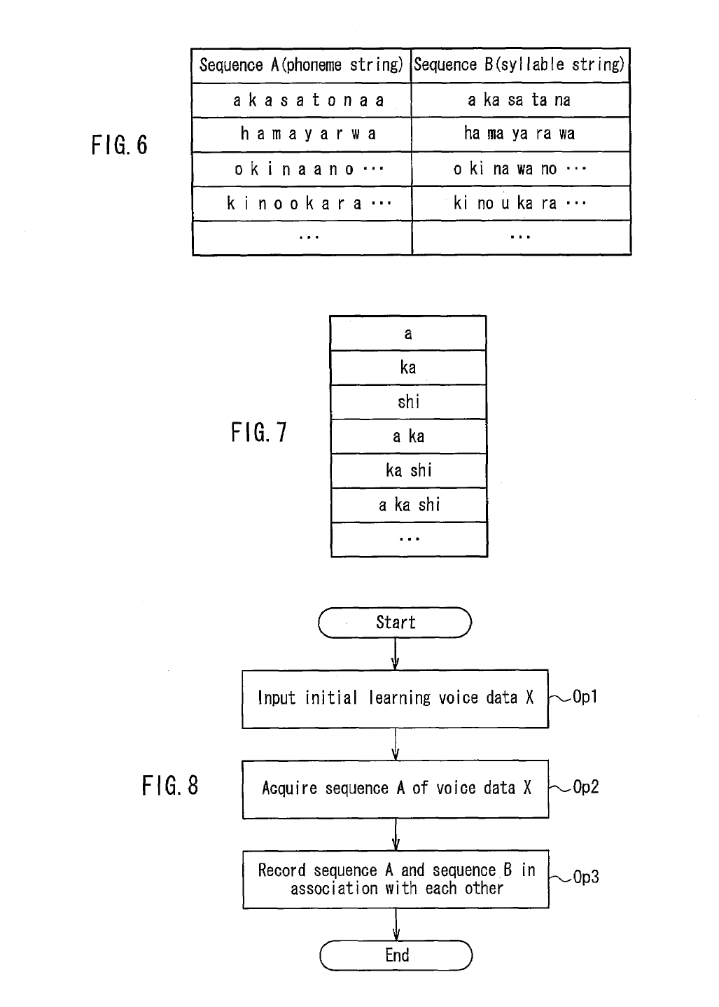

FIG. 6 is a diagram depicting an example of the content of data recorded in the sequence A & sequence B recording unit 3. In the example depicted in FIG. 6, phoneme strings and syllable strings are recorded in association with each other as an example of the sequences A and the sequences B.

In the case of determining that re-learning is necessary, the system monitoring unit 13 outputs an instruction to perform re-learning to the extraction unit 12 and the rule learning unit 9. The extraction unit 12 acquires, from the recognized vocabulary recording unit 23, the reading (syllable string) of a recognized vocabulary word that has been updated or a recognized vocabulary word that has been newly registered. Then, the extraction unit 12 extracts, from the acquired syllable string, syllable string patterns whose lengths correspond to the conversion unit of the conversion rule to be learned, and records the syllable string patterns in the candidate recording unit 11. These syllable string patterns are learned character string candidates. For example, in the case of learning a conversion rule whose conversion unit is one syllable or more, syllable string patterns whose lengths are one syllable or more are extracted. Take the example of the recognized vocabulary word “Akashi”, in which case “a”, “ka”, “shi”, “a ka”, “ka shi”, and “a ka shi” are extracted as learned character string candidates. FIG. 7 is a diagram depicting an example of the content of data recorded in the candidate recording unit 11.

The method by which the extraction unit 12 extracts learned character string candidates is not limited to this. For example, in the case of learning only conversion rules whose conversion unit is two syllables, a configuration is possible in which only two-syllable syllable string patterns are extracted. Also, as another example, the extraction unit 12 may extract syllable string patterns whose numbers of syllables are in a given range (e.g., syllable string patterns having from two to four syllables inclusive). Information indicating what sort of syllable string patterns are to be extracted may be recorded in the rule learning device 1 in advance. Also, the rule learning device 1 may receive, from the user, information indicating what sort of syllable string patterns are to be extracted.

In the case of re-learning, the rule learning unit 9 correlates the combinations of phoneme strings and syllable strings in the sequence A & sequence B recording unit 3 and the learned character string candidates recorded in the candidate recording unit 11, thereby determining conversion rules (as one example here, the correspondence relationship between the phoneme strings and the syllable strings) to be added to the learned rule recording unit 5.

Specifically, the rule learning unit 9 searches the syllable strings recorded in the sequence A & sequence B recording unit for any portions that match the learned character string candidates extracted by the extraction unit 12. If there is a matching portion, the syllable string of the matching portion is determined to be a learned character string. For example, the sequence B (syllable string) “a ka sa ta na” depicted in FIG. 6 includes the learned character string candidates “a ka”, “a”, and “ka” depicted in FIG. 7. In view of this, the rule learning unit 9 can determine “a ka”, “a”, and “ka” to be learned character strings. Alternatively, the rule learning unit 9 may determine only the longest character string “a ka” from among the character strings to be a learned character string.

Then, the rule learning unit 9 determines, from among the phoneme strings recorded in the sequence A & sequence B recording unit, the phoneme string of the portion that corresponds to the learned character string, that is to say, a learned phoneme string. Specifically, the rule learning unit 9 divides the sequence B (syllable string) “a ka sa ta na” into the learned character string “a ka” and the non-learned character string section “sa ta na”, and furthermore partitions the non-learned character string section “sa ta na” into the one-syllable sections “sa”, “ta”, and “na”. The rule learning unit 9 randomly partitions the sequence A (phoneme string) as well into the same number of sections as the sequence B (syllable string).

Then, the rule learning unit 9 evaluates the degree of correspondence between the phoneme string and syllable string of each section with use of a given evaluation function, and repeatedly performs processing for changing the sectioning of the sequence A (phoneme string) so that the evaluation is improved. This obtains optimum sequence A (phoneme string) sectioning that favorably corresponds to the sequence B (syllable string) sectioning. For example, a known technique such as a simulated annealing method or genetic algorithm can be used as the technique for performing such optimization. This enables determining, for example, “akas” as the portion of the phoneme string (i.e., the learned phoneme string) that corresponds to the learned character string “a ka”. Note that the way of obtaining the learned phoneme string is not limited to this example.

The rule learning unit 9 records the learned character string “a ka” and the learned phoneme string “akas” in the learned rule recording unit 5 in association with each other. Accordingly, a conversion rule whose conversion unit is two syllables is added. In other words, learning is performed according to a changed syllable string unit. In the case in which the rule learning unit 9 determines a learned character string out of, for example, learned character string candidates whose character string length is two syllables from among the learned character string candidates extracted by the extraction unit 12, a conversion rule whose conversion unit is two syllables can be added. In this way, the rule learning unit 9 can control the conversion unit of conversion rules that are to be added.

If the system monitoring unit 13 has determined that unnecessary rule determination is necessary, the reference character string creation unit 6 creates, based on basic rules in the basic rule recording unit 4, a phoneme string that corresponds to a learned character string SG of a conversion rule recorded in the learned rule recording unit 5. The created phoneme string is considered to be a reference phoneme string K. The unnecessary rule determination unit 8 compares the reference phoneme string K and a phoneme string (learned phoneme string PG) that corresponds to the learned character string SG in the learned rule recording unit 5, and based on the degree of similarity therebetween, determines whether the conversion rule regarding the learned character string SG and the learned phoneme string PG is unnecessary. Here, such conversion rule is determined to be unnecessary if, for example, the degree of similarity between the learned phoneme string PG and the reference phoneme string K is outside an allowable range that has been set in advance. This degree of similarity is, for example, the difference in the lengths of the learned phoneme string PG and the reference phoneme string K, the number of identical phonemes, or the distance therebetween. The unnecessary rule determination unit 8 deletes a conversion rule determined to be unnecessary from the learned rule recording unit 5.

Allowable range data indicating the allowable range that is used as the bases of the determination performed by the unnecessary rule determination unit 8 is recorded in the threshold value recording unit 17 in advance. Such allowable range data can be updated by a manager of the rule learning device 1 via the setting unit 18. In other words, the setting unit 18 receives an input of data indicating an allowable range from the manager, and updates the allowable range data recorded in the threshold value recording unit 17 based on the input. The allowable range data may be, for example, a threshold value indicating the degree of similarity.

Operations of Rule Learning Device 1: Initial Learning

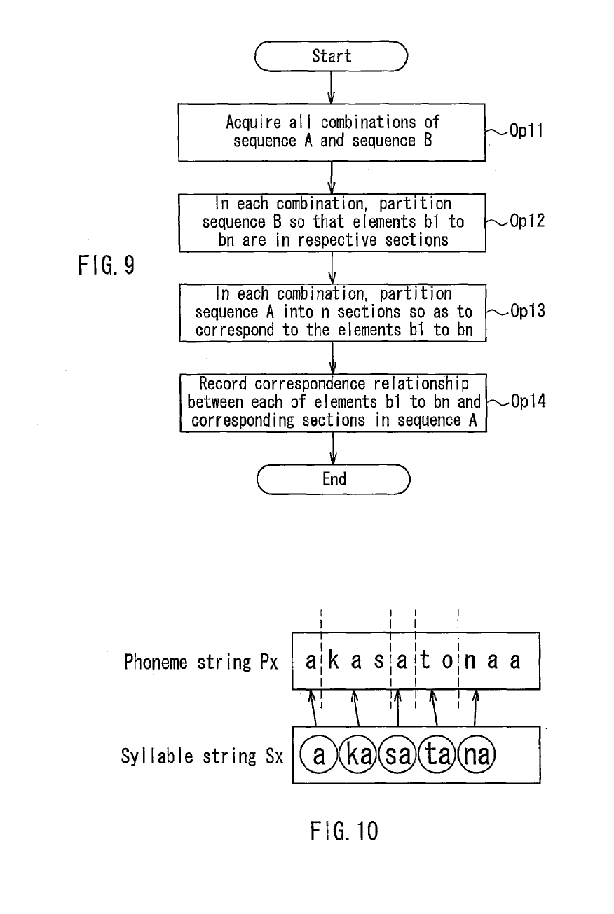

Next is a description of an example of operations performed by the rule learning device 1 in initial learning. FIG. 8 is a flowchart depicting processing in which the system monitoring unit 13 records data for initial learning in the sequence A & sequence B recording unit 3. FIG. 9 is a flowchart depicting processing in which the rule learning unit 9 performs initial learning with use of the data recorded in the sequence A & sequence B recording unit 3.

In the processing depicted in FIG. 8, the system monitoring unit 13 inputs, to the speech recognition device 20, voice data X included in training data Y that has been recorded in the initial learning voice data recording unit 2 in advance (In opration Op1). Here, the training data Y includes the voice data X and a syllable string Sx corresponding thereto. The voice data X is, for example, voice input in the case in which the user has read aloud a given character string (syllable string) such as “a ka sa to na”.

The speech recognition engine 21 of the speech recognition device 20 performs speech recognition processing on the input voice data X and generates a recognition result. The system monitoring unit 13 acquires, from the speech recognition device 20, a phoneme string Px that has been generated in the process of the speech recognition processing and that corresponds to the recognition result thereof, and records the phoneme string Px as a sequence A in the sequence A & sequence B recording unit 3 (in opration Op2).

Also, the system monitoring unit 13 records the syllable string Sx included in the training data Y as a sequence B in the sequence A & sequence B recording unit 3 in association with the phoneme string Px (in opration Op3). Accordingly, a combination of the phoneme string Px and the syllable string Sx that correspond to the voice data X is recorded in the sequence A & sequence B recording unit 3.

By repeating the processing of Op1 to Op3 depicted in FIG. 8 for each of various pieces of training data (combinations of character strings and voice data) that have been recorded in the initial learning voice data recording unit 2 in advance, the system monitoring unit 13 can record a combination of a phoneme string and a syllable string that correspond to each of the character strings.

When the combinations of phoneme strings and syllable strings have been recorded in the sequence A & sequence B recording unit 3 in this way, the rule learning unit 9 executes the initial learning processing depicted in FIG. 9. In FIG. 9, the rule learning unit 9 first acquires all the combinations of a sequence A and a sequence B (in the present embodiment, combinations of phoneme strings and syllable strings) that are recorded in the sequence A & sequence B recording unit 3 (in opration Op11). In the following description, the sequence A and sequence B in each of the acquired combinations are called the phoneme string Px and the syllable string Sx. Then, the rule learning unit 9 partitions the sequence B of each combination into sections b1 to bn, each including an element that is the constituent unit of the sequence B (in opration Op12). In other words, the syllable string Sx of each combination is partitioned into sections that each include a syllable, which is the constituent unit of the syllable strings Sx. For example, in the case in which the syllable string Sx is “a ka sa ta na”, the syllable string Sx is partitioned into five sections, namely “a”, “ka”, “sa”, “ta”, and “na”.

Next, the rule learning unit 9 partitions the phoneme string Px that is the sequence A in each combination into n sections, such that the sections correspond to the sections in the corresponding syllable string Sx (sequence B) (in operation Op13). At this time, the rule learning unit 9 searches for optimum sectioning positions in the phoneme strings Px with use of, for example, an optimizing technique such as is described above.

To give one example, in the exemplary case in which the phoneme string Px is “akasatonaa”, the rule learning unit 9 first randomly partitions “akasatonaa” into n sections. In the exemplary case in which the random sections are “ak”, “as”, “at”, “o”, and “naa”, the correspondence relationship between the sections of the phoneme string Px and the syllable string Sx is determined to be “a→ak”, “ka→as”, “sa→at”, “ta→o”, and “na→naa”. In this way, the rule learning unit 9 obtains the correspondence relationship between the sections in all of the combinations of phoneme strings and syllable strings.

The rule learning unit 9 references all of the correspondence relationships in all of the combinations obtained in this way, and counts the number of types of phoneme strings that correspond to the syllable in each section (pattern number). For example, if the syllable “a” in one section corresponds to the phoneme string “ak”, the same syllable “a” in another section corresponds to the phoneme string “a”, and the syllable “a” in yet another section corresponds to the phoneme string “akas”, there are three types of phoneme strings that correspond to the syllable “a”, namely “a”, “ak”, and “akas” In this case, the type number for the syllable “a” in these sections in 3.

Then, the rule learning unit 9 obtains the total type number in each combination, considers the total type number to be an evaluation function value, and with use of the optimizing technique, searches for optimum sectioning positions so that such value is reduced. Specifically, the rule learning unit 9 repeatedly performs processing in which new sectioning positions in the phoneme string of each combination are calculated with use of a given calculation expression for realizing the optimizing technique, the sections are changed, and the evaluation function value is obtained. Then, for each combination, the sectioning of the phoneme string at which the evaluation function values have converged to a minimum value is determined to be the optimum sectioning that most favorably corresponds to the sectioning of the corresponding syllable string. Accordingly, for each combination, the sections for the sequence A that respectively correspond to the elements b1 to bn of the sequence B are determined.

For example, for the combination of the syllable string Sx and the phoneme string Px, the phoneme string Px is divided into sections that respectively correspond to the sections “a”, “ka”, “sa”, “ta”, and “na” that are the syllables constituting the syllable string Sx. As one example, the phoneme string Px “akasatonaa” is partitioned into the sections “a”, “kas”, “a”, “to”, and “naa” for the five sections “a”, “ka”, “sa”, “ta”, and “na”.

FIG. 10 is a diagram conceptually depicting the correspondence relationship between the sections of the syllable string Sx and the phoneme string Px. In FIG. 10, the partitioning of sections in the phoneme string Px is shown by broken lines. The correspondence relationship of the sections is “a→a”, “ka→as”, “sa→a”, “ta→to”, and “na→naa”.

For each section, the rule learning unit 9 records, in the learned rule recording unit 5, the correspondence relationship between the syllable string and phoneme string (correspondence relationship between the sequence A and sequence B), that is to say a conversion rule (in operation Op14). For example, the above-described correspondence relationships (conversion rules) “a→a”, “ka→kas”, “sa→a”, “ta→to”, and “na→naa” are each recorded. Here, “a→a” indicates that the syllable “a” corresponds to the phoneme “a”. For example, the data for “a→a”, “ka→kas”, and “sa→a” is recorded as depicted in FIG. 5.

Note that in the initial learning of the present example, the conversion unit of the conversion rules to be learned is one syllable However, a conversion rule whose conversion unit is one syllable cannot describe a rule in which a phoneme string corresponds to a plurality of syllables. Also, if the speech recognition device 20 performs correlation processing with use of a one-syllable unit conversion rule, there are cases in which the number of solution candidates when forming recognized vocabulary from syllable strings becomes enormous, and the correct solution candidate is missed due to erroneous detection or pruning.

For this reason, for example, it is possible to generate conversion rules whose conversion unit is two syllables or more in the above-described initial learning. In other words, a conversion rule can be generated and added for all two-syllable combinations included in the syllable strings recorded in the sequence A & sequence B recording unit 3. However, since the number of all two-syllable combinations is enormous, there is an excessive increase in the data size of the conversion rules recorded in the learned rule recording unit 5 and the amount of time required for processing that uses the conversion rules, and there is a high possibility of this becoming an obstacle to the operation of the speech recognition device 20.

In view of this, in initial learning, the rule learning unit 9 of the present embodiment learns conversion rules whose define one syllable as conversion unit as described above. Then, as described below, in re-learning processing, the rule learning unit 9 learns conversion rules whose conversion unit is two syllables or more and furthermore have a high possibility of being used by the speech recognition device 20.

Operations of Rule Learning Device 1: Relearning

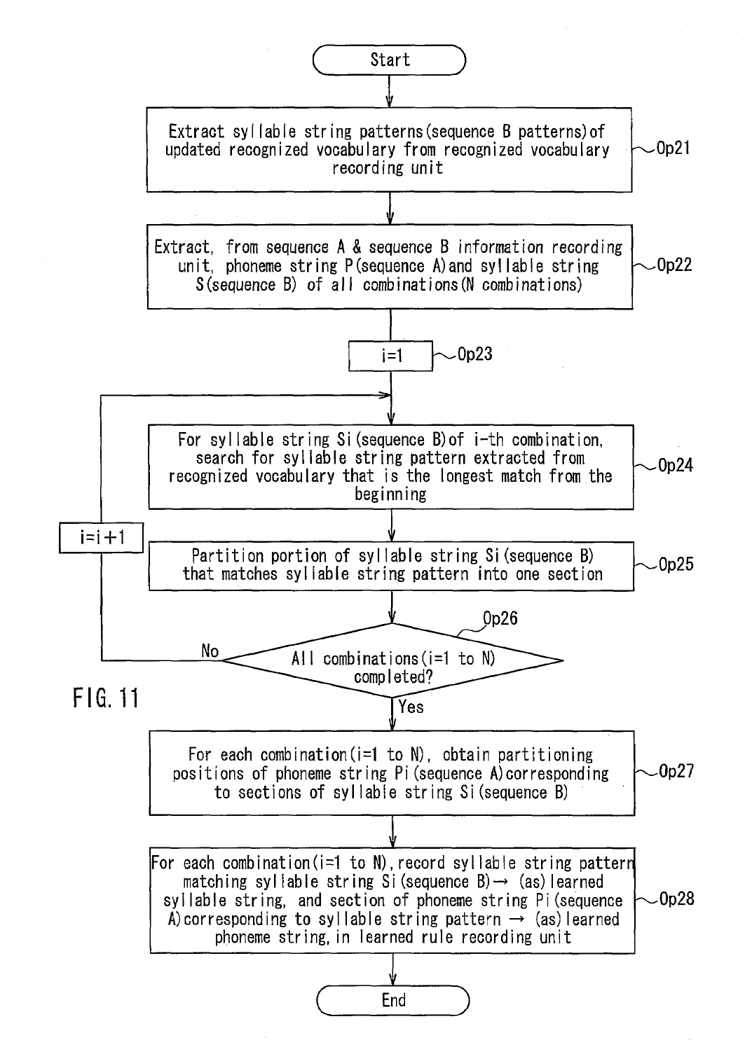

FIG. 11 is a flowchart depicting re-learning processing performed by the extraction unit 12 and the rule learning unit 9. The processing depicted in FIG. 11 includes operations performed in the case in which the extraction unit 12 and the rule learning unit 9 execute re-learning processing upon receiving an instruction from the system monitoring unit 13 if, for example, recognized vocabulary has been newly registered in the recognized vocabulary recording unit 23.

The extraction unit 12 acquires, from among the recognized vocabulary recorded in the recognized vocabulary recording unit 23, the syllable string of a recognized vocabulary word that has been newly registered. Then, the extraction unit 12 extracts syllable string patterns (sequence B patterns) that are one syllable or more in length included in the acquired recognized vocabulary syllable string (In opration Op21). Letting n be the syllable length of the recognized vocabulary word acquired by the extraction unit 12, the extraction unit 12 extracts syllables for which syllable length=1, syllable string patterns for which syllable length=2, syllable string patterns for which syllable length=3, . . . and syllable string patterns whose syllable length is n.

For example, in the case in which the syllable string of the recognized vocabulary word is “Okishima”, ten syllable string patterns are extracted, namely “o”, “ki”, “shi”, “ma”, “o ki”, “ki shi”, “shi ma”, “o ki shi”, “ki shi ma”, and “o ki shi ma”.

Next, the rule learning unit 9 acquires all combinations of a phoneme string P and a syllable string S (N combinations) that are recorded in the sequence A & sequence B recording unit 3 (in operation Op22). The rule learning unit 9 compares the syllable string S of each combination to the corresponding syllable string patterns extracted in Op11, searches for a matching portion, and partitions the matching portion into one section. Specifically, the rule learning unit 9 initializes a variable i to i=1 (in operation Op23), and thereafter repeats the processing of Op24 and Op25 until such processing has ended for all of the combinations (i=1 to N) (until “Yes” is determined in operation Op26).

In operation Op24, for a syllable string Si in the i-th combination, the rule learning unit 9 searches the syllable string patterns extracted in operation Op11 for the longest match from the beginning. In other words, the rule learning unit 9 searches, from the beginning of the syllable string Si, for the longest syllable string pattern that matches the syllable string Si. The following describes the exemplary case in which the syllable string Si is “o ki na wa no”, and the syllable string patterns extracted from the recognized vocabulary words “Okishima” and “Haenawa” are as depicted in Table 2 below.

TABLE 2

| | | | |
|---|---|---|---|
| O | ki | shi | ma |
| o ki | ki shi | shi ma | |
| o ki shi | ki shi ma | | |
| o ki shi ma | | | |
| Ha | e | na | wa |
| Ha e | e na | na wa | |
| Ha e na | e na wa | | |
| Ha e na | | | |
| wa | | | |

In this case, the portions “o ki” and “na wa” of the syllable string Si “o ki na wa no” are the longest matches from the beginning to the syllable string patterns “o ki” and “na wa” in Table 2.

Although the example in which the rule learning unit 9 searches for a longest match from the beginning is given here, the search method is not limited to this. For example, the rule learning unit 9 may limit the syllable string length of the search target to a given value, a search for the longest match from the end is applicable, and a combination of the limitation on the syllable string length and the search for a match from the end is possible. Here, in the exemplary case in which the syllable string length of the search target is limited to two syllables, the syllable string length of conversion rules to be learned is two syllables. For this reason, it is possible to learn only conversion rules whose conversion unit is two syllables.

In operation Op25, rule learning unit 9 partitions a portion of the syllable string Si that matches the syllable string patterns as one section. Note that the portion other than the portion that matches the syllable string patterns is partitioned syllable by syllable For example, the syllable string Si “o ki na wa no” is partitioned into “o ki”, “na wa”, and “no”.

By repeating this processing of Op24 and Op25, the rule learning unit 9 can, for the syllable string Si (i=1 to N) of all combinations acquired in operation Op21, partition a portion that matches a syllable string pattern into a section. Thereafter, the rule learning unit 9 partitions the phoneme string Pi of each combination so as to correspond to the sections in the syllable string Si of the corresponding combination (in operation Op27). The processing of Op27 can be performed likewise to the processing of Op13 in FIG. 9. Accordingly, it is possible to obtain phoneme strings corresponding to portions that match the syllable string patterns of the syllable string Si in each combination.

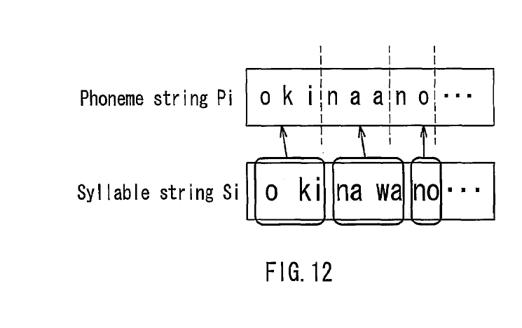

FIG. 12 is a diagram conceptually depicting the correspondence relationship between the sections in the syllable string Si and the phoneme string Pi. In FIG. 12, the partitioning of sections in the phoneme string Pi is shown by broken lines. The correspondence relationship between the sections is “o ki→oki”, “na wa→naa”, and “no→no”.

For each section including a portion of the syllable string Si that matches a syllable string pattern, the rule learning unit 9 records the correspondence relationship between the syllable string and the phoneme string (i.e., a conversion rule) in the learned rule recording unit 5 (in operation Op28). For example, the above-described correspondence relationships (conversion rules) “o ki→oki” and “na wa→naa” are each recorded. Here, the syllable string patterns “o ki” and “na wa” that match the syllable string Si are learned syllable strings, and the respectively corresponding sections “oki” and “naa” of the phoneme string Pi are learned phoneme strings. For example, the data for “na wa→naa” is recorded as depicted in FIG. 5.

According to the processing of re-learning depicted in FIG. 11, conversion rules whose conversion unit is one syllable or more are learned only for character strings (syllable strings) included in recognized vocabulary. In other words, the rule learning device 1 dynamically changes the conversion unit between phoneme strings (sequences A) and syllable strings (sequences B) in accordance with recognized vocabulary that has been updated or registered in the recognized vocabulary recording unit 23. Accordingly, it is possible to learn conversion rules having a larger conversion unit, and it is also possible to suppress the case in which the amount of conversion rules to be learned becomes enormous, and efficiently learn conversion rules that have a high possibility of being used.

In the re-learning described above, there is no need to use training data in the initial learning voice data recording unit 2. For this reason, in re-learning, it is sufficient for the rule learning device 1 to acquire only recognized vocabulary recorded in the recognized vocabulary recording unit 23 of the voice detection device 20. Therefore, even if training data cannot be prepared in the case such as a sudden change in task in the speech recognition device 20, it is possible to immediately respond by performing re-learning when recognized vocabulary has been updated along with the task change. In other words, the rule learning device 1 can re-learn conversion rules even if there is no training data.

For example, assume that in the case in which the task of the speech recognition device 20 is to provide voice guidance regarding road traffic information, a voice guidance task regarding fishing industry information is suddenly also added. In such a case, it is possible for a situation to occur in which recognized vocabulary regarding the fishing industry (e.g., “Okishima” and “Haenawa”) has been added to the recognized vocabulary recording unit 23, but training data for such recognized vocabulary cannot be prepared. In this way, even if training data has not been newly provided, the rule learning device 1 can automatically learn conversion rules corresponding to the added recognized vocabulary and add such rules to the rule learning unit 9. As a result, the speech recognition device 20 can promptly respond to the fishing industry information guidance task.

Note that the re-learning processing depicted in FIG. 11 is exemplary, and the re-learning processing is not limited to this. For example, the rule learning unit 9 can have recorded therein conversion rules that have been learned in the past, and merge such conversion rules with re-learned conversion rules. For example, if the rule learning unit 9 has learned the following three conversion rules in the past:

a i→ai

i u→yuu

u e→uwe

and furthermore the following two conversion rules have been newly learned in re-learning:

i u→yuu

e o→eho

the rule learning unit 9 can create a conversion rule data set such as the following below by merging the past learning result and the new re-learning result. Specifically, since “i u→yuu” is the same in both the past learning result and the new re-learning result, the rule learning unit 9 can delete one or the other.

Operations of Rule Learning Device 1: Unnecessary Rule Determination

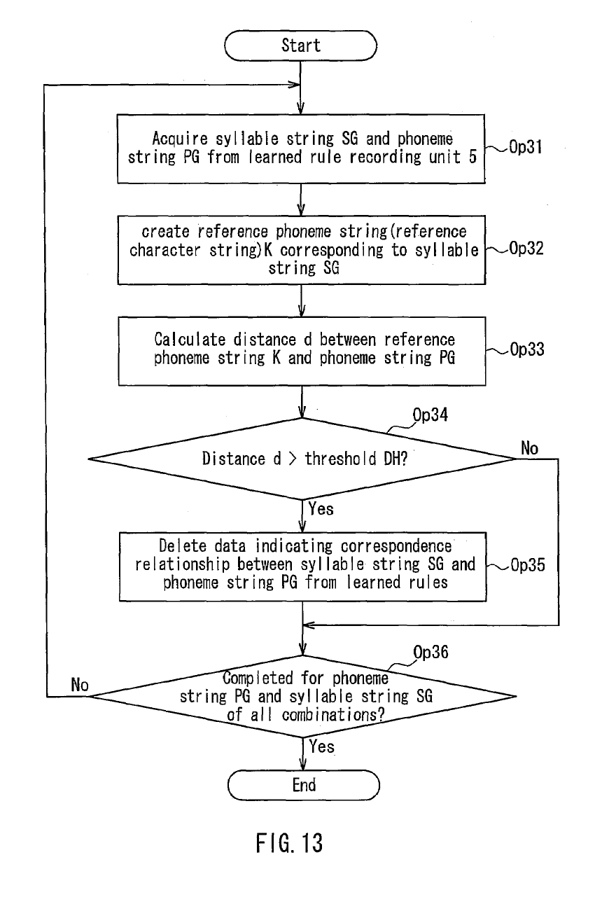

Next is a description of unnecessary rule deletion processing. FIG. 13 is a flowchart depicting an example of unnecessary rule deletion processing performed by the reference character string creation unit 6 and the unnecessary rule determination unit 8. In FIG. 13, first the reference character string creation unit 6 acquires a combination of a learned syllable string SG and a corresponding learned phoneme string PG that is shown in a conversion rule recorded in the learned rule recording unit 5 (in operation Op31). As one example here, the following describes the case in which the combination of learned syllable string SG=“a ka” and learned phoneme string PG=“akas” is acquired from the data in the learned rule recording unit 5 depicted in FIG. 5.

The reference character string creation unit 6 creates a reference phoneme string (reference character string) K corresponding to the learned syllable string SG with use of the conversion rules recorded in the basic rule recording unit 4 (in operation Op32). For example, as depicted in FIG. 4, the basic rule recording unit 4 records a phoneme string corresponding to each syllable as conversion rules. For this reason, the reference character string creation unit 6 creates a reference phoneme string by replacing the syllables in the learned syllable string SG with phoneme strings one syllable at a time based on the conversion rules in the basic rule recording unit 4.

For example, in the case in which learned syllable string SG=“a ka”, the reference phoneme string “aka” is created with use of the conversion rules “a→a” and “ka→ka” depicted in FIG. 4. The created reference phoneme string K is recorded in the reference character string recording unit 7.

The unnecessary rule determination unit 8 compares the reference phoneme string K “aka” recorded in the reference character string recording unit 7 and the learned phoneme string PG “akas”, and calculates a distance d indicating the degree of similarity between the two (in operation Op33). The distance d can be calculated with use of a DP correlation method or the like.

If the distance d between the reference phoneme string K and the learned phoneme string PG that was calculated in operation Op33 is greater than a threshold value DH recorded in the threshold value recording unit 17 (in operation Op34: Yes), the unnecessary rule determination unit 8 determines the conversion rule regarding the learned phoneme string PG is unnecessary, and deletes such conversion rule from the learned rule recording unit 5 (in operation Op35).

The processing of the above Op31 to Op35 is repeated for all conversion rules that are recorded in the learned rule recording unit 5 (i.e., all combinations of learned syllable strings and learned phoneme strings). Accordingly, a conversion rule regarding a learned phoneme string PG whose distance is far removed from the reference phoneme string K (low degree of similarity) is considered to be an unnecessary rule and is deleted from the learned rule recording unit 5. This enables removing conversion rules that have the possibility of causing erroneous conversion, and furthermore enables reducing the amount of data recorded in the learned rule recording unit 5.

Note that as an example of a case in which a conversion rule is determined to be an unnecessary rule, if learned syllable string SG=“na wa”, reference phoneme string K=“nawa”, and learned phoneme string PG=“moga”, such conversion rule is determined to be unnecessary since there is a large difference between the phoneme content of PG and K. In the case of learned phoneme string PG=“nawanoue” as well, such conversion rule is determined to be unnecessary since there is a large difference between the phoneme string lengths.

Note that the degree of similarity calculated in operation Op33 is not limited to being the distance d calculated using the DP correlation method. The following describes a variation of the degree of similarity calculated in operation Op33. For example, the unnecessary rule determination unit 8 may calculate the degree of similarity based on how many phonemes are identical between the reference phoneme string K and the learned phoneme string PG. Specifically, the unnecessary rule determination unit 8 may calculate a percentage W of phonemes included in the learned phoneme string PG that are the same as phonemes in the reference phoneme string K, and obtain the degree of similarity based on the percentage W. As one example, the calculation can be performed according to: degree of similarity =W×constant A (A>0).

Also, as another example of the degree of similarity, the unnecessary rule determination unit 8 may obtain the degree of similarity based on a difference U between the phoneme string lengths of the reference phoneme string K and the learned phoneme string PG. As one example, the calculation can be performed according to: degree of similarity=U×constant B (B<0). Alternatively, taking both the difference U and the percentage W into consideration, the calculation can be performed according to: degree of similarity=U×constant B+W×constant A.

Also, when comparing the phonemes in the learned phoneme string and the reference phoneme string in the calculation of the degree of similarity, the unnecessary rule determination unit 8 can calculate the degree of similarity with use of data indicating a tendency of errors in speech recognition (e.g., insertion, substitution, or missing portions) that has been provided in advance. Accordingly, the degree of similarity can be calculated taking into consideration a tendency for insertion, substitution, or missing portions. Here, an error in speech recognition refers to conversion that does not follow ideal conversion rules.

For example, consider the case in which conversion was performed according to “a→a”, “kas→ka”, “a→sa”, “to→ta”, and “naa→na” as depicted in FIG. 10. In the case where the ideal conversion rules are “a→a”, “ka→ka”, “sa→sa”, “ta→ta”, and “na→na”, the conversion “ka→kas” has an “s” inserted in the ideal conversion result “ka”. Also, with the conversion “ta→to”, the “a” in the ideal conversion result has been substituted with an “o”. Furthermore, with the conversion “sa→a”, an “s” is missing from the ideal conversion result. An example of the content of such data indicating tendencies in the speech recognition device 20 for errors such as insertion, substitution, and missing portions is depicted in Table 3 below, and is recorded in the rule learning device 1 or the speech recognition device 20.

TABLE 3

| | Ideal phoneme | Erroneous | |
|---|---|---|---|
| Syllable | string | phoneme string | Frequency |
| Ka | ka | kas | 2 |
| Sa | sa | a | 4 |
| Ta | ta | to | 31 |

For example, in the case in which the characters in the corresponding reference phoneme string are “ta”, and the phoneme in the learned phoneme string is “to”, the unnecessary rule determination unit 8 may treat “ta” and “to” as the same characters if the frequency of substitution error between “ta” and “to” in the tendency depicted in Table 3 is greater than or equal to a threshold value. Alternatively, in calculating the degree of similarity, the unnecessary rule determination unit 8 may, for example, perform weighting so as to increase the degree of similarity between “ta” and “to”, or add a degree of similarity value (point).

Although a variation of the calculation of the degree of similarity has been described above, the calculation of the degree of similarity is not limited to the above example. Also, although the unnecessary rule determination unit 8 determines whether a conversion rule is necessary by comparing a reference phoneme string and a learned phoneme string in the present embodiment, the determination can be made without using a reference phoneme string. For example, the unnecessary rule determination unit 8 may determine whether a conversion rule is necessary based on the frequency of appearance of at least either a learned phoneme string or a learned syllable string.

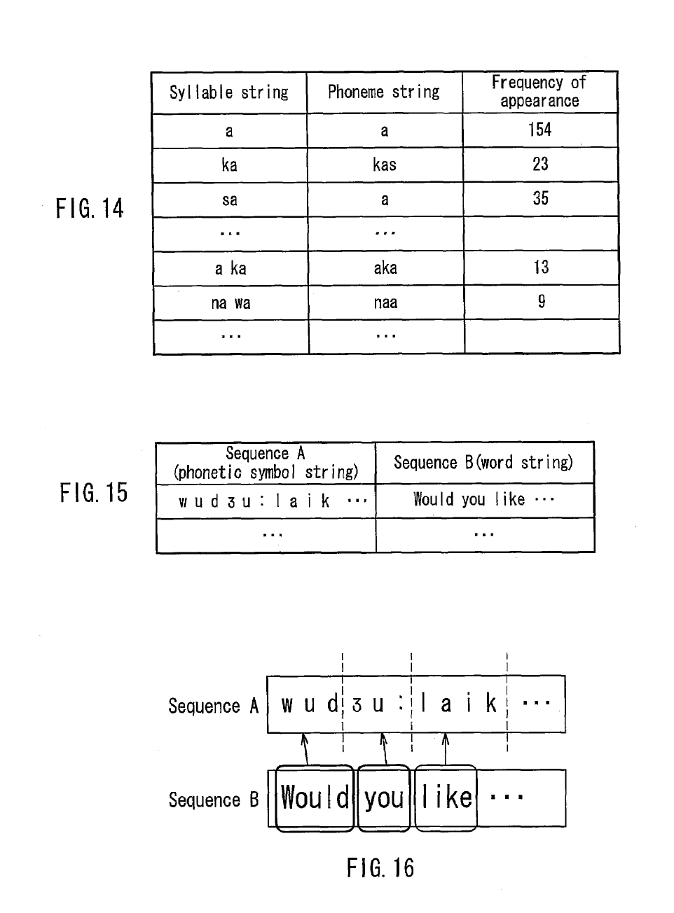

In this case, the data of the conversion rules recorded in the learned rule recording unit 5 is, for example, content such as is depicted in FIG. 14. The content of the data depicted in FIG. 14 includes the content of the data depicted in FIG. 5 with the further addition of data indicating the frequency of appearance of each learned syllable string. By sequentially referencing such data indicating frequencies of appearance, the unnecessary rule determination unit 8 can determine that a conversion rule regarding a learned syllable string whose frequency of appearance is lower than a given threshold is unnecessary and delete such conversion rule.

Note that to obtain the frequencies of appearance depicted in FIG. 14, for example, each time a syllable string is generated in speech recognition processing by the speech recognition engine 21 of the speech recognition device 20, the syllable string can be notified to the rule learning device 1, and the learned rule recording unit 5 in the rule learning device 1 can update the frequency of appearance of the notified syllable string.

Note that the method of recording the data indicating frequencies of appearance is not limited to the above example. For example, a configuration is possible in which the speech recognition device 20 has recorded therein the frequencies of appearance of the syllable strings, and the unnecessary rule determination unit 8 references the frequencies of appearance recorded in the speech recognition device 20 when performing unnecessary rule determination.

Also, besides performing unnecessary rule determination based on the frequencies of appearance, unnecessary rule determination can be performed based on the length of at least either a learned syllable string or a learned phoneme string. For example, the unnecessary rule determination unit 8 may sequentially reference the syllable string lengths of the learned syllable strings recorded in the learned rule recording unit 5 such as are depicted in FIG. 4, and if a syllable string length is greater than or equal to a given threshold value, the unnecessary rule determination unit 8 may determine that the conversion rule regarding such learned syllable string is unnecessary, and delete the conversion rule for the learned syllable string.

Also, the threshold values indicating the allowable ranges of the degree of similarity, frequency of appearance, or length of a syllable string or phoneme string in the above description may be values indicating both the upper limit and lower limit, or may be a value expressing one or the other. Such threshold values are recorded in the threshold value recording unit 17 as allowable range data. The manager can adjust such threshold value via the setting unit 18. This enables dynamically changing the determination reference used in unnecessary rule determination.

Note although the example in which the unnecessary rule determination unit 8 deletes an unnecessary conversion rule as processing performed after initial learning and re-learning has been described in the present embodiment, it is possible to, for example, prevent unnecessary conversion rules from being recorded in the learned rule recording unit 5 by performing such determination at the time of the re-learning processing performed by the rule learning unit 9.

Other Examples of Sequence A and Sequence B

Although the case in which the sequence A is a phoneme string and the sequence B is a syllable string has been described in the present embodiment, the following describes other possible forms of the sequence A and the sequence B. The sequence A is, for example, a character string that expresses a sound, such as a symbol string corresponding to sounds. The notation and language of the sequence A are arbitrary. Examples of the sequence A include phonemic symbols, phonetic symbols, and ID number strings allocated to sounds, such as are depicted in Table 4 below.

TABLE 4

| Phonemic symbols | /a/, /i/, /u/, /e/, /o/, /k/, /s/, . . . |
|---|---|
| Phonetic symbols | /i/, /e/, /æ/, /a/, / [symbol] /, /u/, / [symbol] /. . . |
| ID number string | /01/02/03/. . . |

The sequence B is, for example, a character string for constituting a recognition result of speech recognition, and may be the actual character string constituting a recognition result, or may be an intermediate character string at a stage before constituting a recognition result. Also, the sequence B may be an actual recognized vocabulary word recorded in the recognized vocabulary recording unit 23, or may be character strings uniquely obtained by converting a recognized vocabulary word. The notation and language of the sequence B are also arbitrary. Examples of the sequence B include Japanese character strings, hiragana strings, katakana strings, alphabet letters, and ID number strings allocated to characters (strings), such as are depicted in Table 5 below.

TABLE 5

| Japanese characters | [symbol] |
|---|---|
| Hiragana | [symbol] |
| Katakana | [symbol] |
| Alphabet letters or Roman | A, B, C, . . . , a, b, c . . . |
| characters | |
| ID number string | 001, 002, 003 . . . |

Also, although the case in which processing for conversion between two sequences, such as the sequence A and the sequence B, is described in the present embodiment, processing for conversion between two or more sequences may be performed. For example, the speech recognition device 20 may perform conversion processing in multiple stages, such as phonemic symbol→phoneme ID→syllable string (hiragana). Below is an example of such conversion processing. /a/ /k/ /a/→[01][06][01] →“a ka” In this case, the rule learning device 1 can set the target of learning to be either conversion rules between phonemic symbols and phoneme IDs, or conversion rules between phoneme IDs and syllable strings, or both of these.

Example of Data in the Case of English

Although the case of learning conversion rules used in a Japanese speech recognition device has been described in the present embodiment, the present invention is not limited to Japanese, and can be applied to an arbitrary language. The following describes an example of data in the case of applying the above embodiment to English. Here, as one example, the following describes the case in which the sequence A is a phonetic symbol string, and the sequence B is a word string. In this example, the respective words included in the word strings are elements that are constituent units of the sequence B.

FIG. 15 is a diagram depicting an example of the content of data recorded in the sequence A & sequence B recording unit 3. In the example depicted in FIG. 15, phonetic symbol strings are recorded as the sequences A, and word strings are recorded as the sequences B. As described above, the rule learning unit 9 performs initial learning and re-learning processing with use of the sequence Aphonetic symbol strings and the sequence B word strings that are recorded in the sequence A & sequence B recording unit 3.

For example, in initial learning, the rule learning unit 9 learns conversion rules whose conversion unit is one word, and in re-learning, learns conversion rules whose conversion unit is one word or more.

FIG. 16 is a diagram conceptually depicting the correspondence relationship between sections of a sequence Aphonetic symbol string and sections of a sequence B word string, that are obtained by the rule learning unit 9 in initial learning. Likewise to the processing depicted in FIG. 9 described above, the sequence B word string is partitioned word-by-word, and the sequence Aphonetic symbol string is partitioned so as to correspond thereto. Accordingly, phonetic symbol strings (sequences B) that respectively correspond to the words (elements of the sequence A) are obtained and recorded in the learned rule recording unit 5.

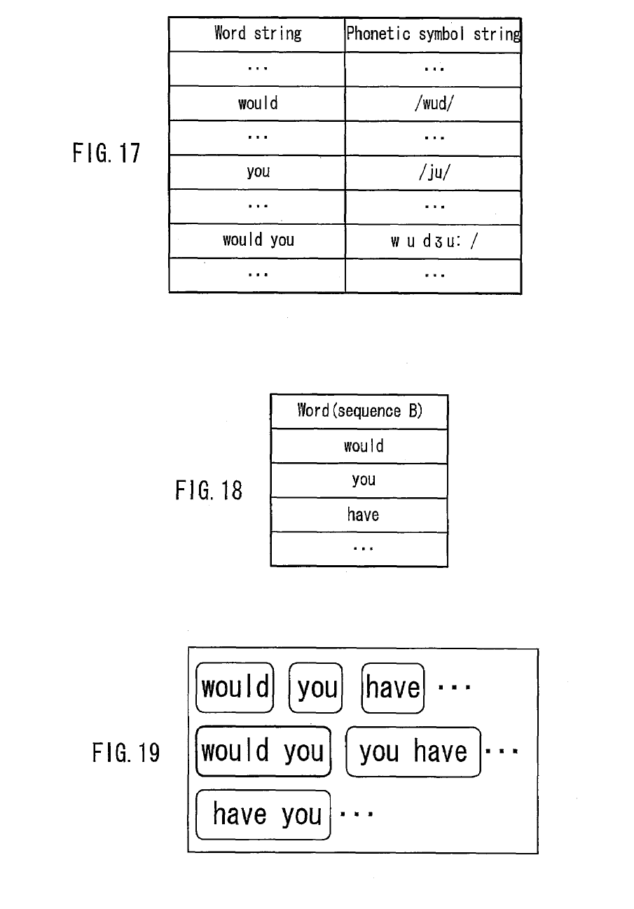

FIG. 17 is a diagram depicting an example of the content of data recorded in the learned rule recording unit 5. For example, in FIG. 17, conversion rules for the words “would” and “you” are conversion rules recorded in initial learning. In re-learning, a conversion rule for the word string “would you” is further recorded. In other words, the conversion rule for the word string “would you” is learned through re-learning processing that is similar to the processing depicted in FIG. 11. The following describes the exemplary case of applying the processing of FIG. 11 to English.

In operation Op22 of FIG. 11, the extraction unit 12 extracts sequence B patterns from a recognized vocabulary word that has been updated in the recognized vocabulary recording unit 22. FIG. 18 is a diagram depicting an example of the content of data stored in the recognized vocabulary recording unit 22. In the example depicted in FIG. 18, the recognized vocabulary is expressed by words (sequences B). The extraction unit 12 extracts, from the recognized vocabulary recording unit 22, patterns of combinations of words that can be joined, that is to say, sequence B patterns. Grammar rules that have been recorded in advanced are used in such extraction. For example, the grammar rules are a collection of rules stipulating how words can be joined with other words. For example, grammar data such as the above-described CFG, FSG, or N-gram can be used as such grammar rules.

FIG. 19 is a diagram depicting an example of sequence B patterns extracted from the words “would”, “you”, and “have” in the recognized vocabulary recording unit 22. In the example depicted in FIG. 19, “would”, “you”, “have”, “would you”, “you have”, and “have you” have been extracted. The rule learning unit 9 compares such sequence B patterns and the word string (sequence B, such as “would you like . . . ”) in the sequence A & sequence B recording unit 3, and searches for the longest matching portion from the beginning (in operation Op24). The rule learning unit 9 then sets a portion that matches such sequence B pattern (in this example, “would you”) as one section and partitions the word string (sequence B) (in operation Op25), and partitions each word not in the portion that matches the sequence B pattern into a separate section. Then, the rule learning unit 9 calculates sections of the phonetic symbol string (sequence A) that respectively correspond to the sections of such sequence B (in operation Op27).

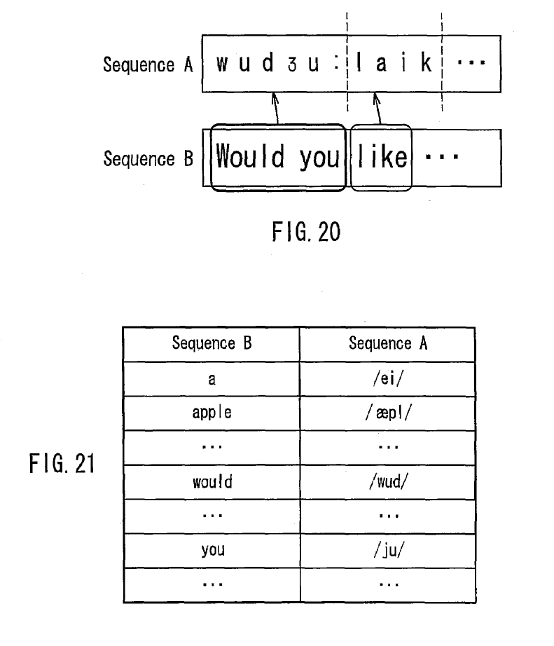

FIG. 20 is a diagram conceptually depicting the correspondence relationship between the sections of the sequence A phonetic symbol string and the sections “would you”, “like”, and the like of the sequence B word string. The correspondence relationship for the word string “would you” depicted in FIG. 20 is recorded as a conversion rule in the learned rule recording unit 5 as depicted in, for example, FIG. 17. In other words, a conversion rule regarding the learned word string “would you” is recorded as an addition to the learned rule recording unit 5. The above is an example of the content of data in re-learning.

Among the conversion rules learned in this way, an unnecessary conversion rule is deleted through the unnecessary rule determination processing depicted in FIG. 13. At this time, in operation Op32, ideal conversion rules (a general dictionary) that have been recorded in the basic rule recording unit 4 in advance are used. FIG. 21 is a diagram depicting an example of the content of data recorded in the basic rule recording unit 4. In the example depicted in FIG. 21, words and phonetic symbol strings that respectively correspond thereto are recorded. Accordingly, the reference character string creation unit 6 converts each word in the learned word strings recorded in the learned rule recording unit 5 into phonetic symbol strings, and creates reference symbol strings (reference character strings). Table 6 below is a table depicting examples of reference symbol strings and learned phonetic symbol strings that are to be compared thereto.

TABLE 6

| | | Learned phonetic symbol |
|---|---|---|
| Learned word string | Reference symbol string | string |
| would you | wudju | wud3 u |
| would you | wudju | laik |
| would you | wudju | wud3 u: laik |

In Table 6, for example, the conversion rule for the learned phonetic symbol string in the first row is not determined to be unnecessary, but none of the phonetic symbols in the learned phonetic symbol string in the second row match the reference symbol string, and therefore the unnecessary rule determination unit 8, for example, calculates a low degree of similarity for such learned phonetic symbol string and determines that the conversion rule regarding such learned phonetic symbol string is unnecessary. In the learned phonetic symbol string in the third row, the difference between the symbol string lengths of the reference symbol string and the learned phonetic symbol string is “4”. If the threshold value is, for example, “3”, it is determined that the conversion rule regarding such learned phonetic symbol string is unnecessary.

This completes the description of the example of data in the case of learning conversion rules used in English speech recognition. The rule learning device 1 of the present embodiment is not limited to English, but instead can be likewise applied to other languages as well.

According to the above embodiment, it is possible to re-learn and construct a minimum necessary amount of conversion rules specialized for a task without using new training data (voice data). This realizes an improvement in the speech recognition accuracy of, a reduction in resource use by, and an increase in the speed of the speech recognition device 20.

### INDUSTRIAL APPLICABILITY

The present invention is useful as a rule learning device that automatically learns conversion rules used by a speech recognition device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A speech recognition rule learning device connected to a speech recognition device that generates a recognition result by executing correlation processing which matches input voice data with an acoustic model and a word dictionary by using conversion rules for conversion between a first-type character string expressing a sound and a second-type character string for forming a recognition result, the speech recognition rule learning device comprising:
a character string recording unit that records, in association with each other, a first-type character string generated in a process in which a recognition result is generated by the speech recognition device, and a second-type character string corresponding to the first-type character string;
an extraction unit that extracts, from a second-type character string corresponding to a word recorded in the word dictionary, character strings each constituted by a series of second-type elements that are constituent units of the second-type character string, as second-type learned character string candidates; and
a rule learning unit that (i) selects a second-type learned character string, from among the second-type learned character string candidates extracted by the extraction unit, that matches at least part of the second-type character string recorded in the character string recording unit, (ii) extracts, from the first-type character string recorded in the character string recording unit in association with the second-type character string, a portion that corresponds to the second-type learned character string, as a first-type learned character string, and (iii) includes, in the conversion rules used by the speech recognition device, data indicating a correspondence relationship between the first-type learned character string and the second-type learned character string.

2. The speech recognition rule learning device according to claim 1, further comprising:
a basic rule recording unit that has recorded in advance basic rules that are data indicating ideal first-type character strings that respectively correspond to the second-type elements that are constituent units of the second-type character string; and
an unnecessary rule determination unit that generates, as a first-type reference character string, a first-type character string corresponding to the second-type learned character string with use of the basic rules, calculates a value indicating a degree of similarity between the first-type reference character string and the first-type learned character string, and determines that, if the value is in a given allowable range, the first-type learned character string is to be included in the conversion rules.

3. The speech recognition rule learning device according to claim 2,
wherein the unnecessary rule determination unit calculates the value indicating the degree of similarity based on at least one of a difference between character string lengths of the first-type reference character string and the first-type learned character string, and a percentage of identical characters in the first-type reference character string and the first-type learned character string.

4. The speech recognition rule learning device according to claim 1, further comprising an unnecessary rule determination unit that, if a frequency of appearance in the speech recognition device of at least one of the first-type learned character string extracted by the rule learning unit and the second-type learned character string is in a given allowable range, determines that the data indicating the correspondence relationship between the first-type learned character string and the second-type learned character string is to be included in the conversion rules.

5. The speech recognition rule learning device according to any one of claims 1, further comprising:
a threshold value recording unit that records allowable range data indicating the given allowable range; and
a setting unit that receives an input of data indicating an allowable range from a user, and updates the allowable range data recorded in the threshold value recording unit based on the input.

6. A speech recognition device comprising:
a speech recognition unit that generates a recognition result by executing correlation processing which matches input voice data with an acoustic model and a word dictionary;
a rule recording unit that records conversion rules that are used by the speech recognition unit in the correlation processing and that are for conversion between a first-type character string expressing a sound and a second-type character string for forming a recognition result;
a character string recording unit that records, in association with each other, a first-type character string generated in a process in which a recognition result is generated by the speech recognition unit, and a second-type character string corresponding to the first-type character string;
an extraction unit that extracts, from a second-type character string corresponding to a word recorded in the word dictionary, character strings each constituted by a series of second-type elements that are constituent units of the second-type character string, as second-type learned character string candidates; and
a rule learning unit that (i) selects a second-type learned character string, from among the second-type learned character string candidates extracted by the extraction unit, that matches at least part of the second-type character string recorded in the character string recording unit, (ii) extracts, from the first-type character string recorded in the character string recording unit in association with the second-type character string, a portion that corresponds to the second-type learned character string, as a first-type learned character string, and (iii) includes, in the conversion rules used by the speech recognition unit, data indicating a correspondence relationship between the first-type learned character string and the second-type learned character string.

7. A speech recognition rule learning method for causing a speech recognition device that generates a recognition result by executing correlation processing which matches input voice data with an acoustic model and a word dictionary, to learn conversion rules that are used in the correlation processing and that are for conversion between a first-type character string expressing a sound and a second-type character string for forming a recognition result, the method comprising
steps that are executed by a computer including a character string recording unit that records, in association with each other, a first-type character string generated in a process in which a recognition result is generated by the speech recognition device, and a second-type character string corresponding to the first-type character string,
wherein the steps includes:
extracting, from a second-type character string corresponding to a word recorded in the word dictionary, character strings each constituted by a series of second-type elements that are constituent units of the second-type character string, as second-type learned character string candidates; and
rule learning processing to select a second-type learned character string, from among the second-type learned character string candidates extracted by the extraction unit, that matches at least part of the second-type character string recorded in the character string recording unit, (ii) extract, from the first-type character string recorded in the character string recording unit in association with the second-type character string, a portion that corresponds to the second-type learned character string, as a first-type learned character string, and (iii) include, in the conversion rules used by the speech recognition device, data indicating a correspondence relationship between the first-type learned character string and the second-type learned character string.

8. A speech recognition rule learning program product for causing a computer to perform processing, the computer being connected to or included in a speech recognition device that that generates a recognition result by executing correlation processing which matches input voice data with an acoustic model and a word dictionary by using conversion rules for conversion between a first-type character string expressing a sound and a second-type character string for forming a recognition result, the speech recognition rule learning program causing the computer to execute:
a process of accessing a character string recording unit that records, in association with each other, a first-type character string generated in a process in which a recognition result is generated by the speech recognition device, and a second-type character string corresponding to the first-type character string;
an extraction process of extracting, from a second-type character string corresponding to a word recorded in the word dictionary, character strings each constituted by a series of second-type elements that are constituent units of the second-type character string, as second-type learned character string candidates; and
a rule learning process of (i) selecting a second-type learned character string, from among the second-type learned character string candidates extracted in the extraction process, that matches at least part of the second-type character string recorded in the character string recording unit, (ii) extracting, from the first-type character string recorded in the character string recording unit in association with the second-type character string, a portion that corresponds to the second-type learned character string, as a first-type learned character string, and (iii) including, in the conversion rules used by the speech recognition device, data indicating a correspondence relationship between the first-type learned character string and the second-type learned character string.
